(19) United States
(12) Patent Application Publication
(10) Pub. No.: US 2023/0138699 A1
(43) Pub. Date: May 4, 2023

(54) Systems and Methods of Creating and Using a Transparent, Computer-processable Contractual Natural Language

(71) Applicant: Jana Sukkarieh, Princeton, NJ (US)

(72) Inventor: Jana Sukkarieh, Princeton, NJ (US)

(21) Appl. No.: 18/089,329

(22) Filed: Dec. 27, 2022

Related U.S. Application Data
(63) Continuation-in-part of application No. 17/703,213, filed on Mar. 24, 2022, now Pat. No. 11,573,968.
(60) Provisional application No. 63/165,317, filed on Mar. 24, 2021.
(60) Provisional application No. 63/323,129, filed on Mar. 24, 2022.

(51) Int. Cl. G06F 40/211; G06F 40/169; G06F 40/289; G06Q 50/18

(52) U.S. Cl. CPC G06F 40/211; G06F 40/169; G06F 40/289; G06Q 50/18

(57) ABSTRACT

System and methods of creating and using a transparent, computer processable contractual natural language are disclosed in which a set of legal contracts are annotated to obtain a structured contractual database. A set of categorized contractual phrases are assembled from the structured contractual database. A transparent knowledge representation language is defined having a set of syntax rules, a set of semantic rules and a set of inference rules. A transparent, computer-processable contractual natural language is the subset of contractual phrases that map to the transparent knowledge representation language. A user writes computer-processable legal documents comprised of phrases contained in the transparent, computer-processable contractual natural language.

### CROSS-REFERENCE TO RELATED APPLICATIONS

This is a continuation-in-part application of U.S. Ser. No. 17/703,213 entitled “Systems and Methods of Creating and Using a Transparent, Computable Contractual Natural Language” that was filed on Mar. 24, 2022 that in turn claims priority to US provisional application U.S. 63/165,317 entitled “Transparent Legal Language Representation and Mining” filed on Mar. 24, 2021, and to US provisional application U.S. 63/323,129 entitled “Builder for Smarter Contracts: Transparent Legal Language Representation and Reasoning” filed on Mar. 24, 2022, the contents of all of which are hereby fully incorporated by reference.

### BACKGROUND OF THE INVENTION

### (1) Field of the Invention

The invention relates to systems and methods of creating and using transparent, computer-processable contractual natural languages. More particularly, it relates to creating such languages by first using annotation to obtain a structured contractual database containing evidentiary texts comprised of categorized legal-phemes that may be assembled into a set of categorized contractual phrases in a natural language. A transparent, computer-processable contractual natural language may then be the subset of these categorized contractual phrases that map to a transparent knowledge representation language. The transparent, computer-processable contractual natural language may be used for producing human readable, computer-processable documents, particularly human readable, computer-processable legal contracts, and human readable computer-processable contract templates.

### (2) Description of Related Art

Traditional legal contracts tend to be agreements represented in lengthy, often ambiguous legalese-loaded documents that are sometimes only intelligible to seasoned legal professionals. They are often the result of customization of historical templates or are previous contracts that have been edited and appended as an original contract gets applied to transaction after transaction over periods of time. This almost invariably results in terms and conditions that are either disparate, contradictory, or ambiguous due to legacy verbiage that carries over from contract to contract.

There are attempts to counter these deficiencies. One such attempt is by producing smart contracts that may be machine readable. These contracts may use technologies such as the Industrial Internet of Things (IIoT) and Distributed Ledger Technology (DLT), aka blockchains, to capture, verify, validate, and enforce agreed-upon terms between multiple parties. A smart contract takes real-world, legally governed events and collects IIoT data for performance measurements including information from sensors, meters, and other business processes. This data then informs the automated terms of a contract by posting results and accompanying proof to the blocks.

Such smart contracts are typically software programs that automate the execution of contract terms. However, the computable part applies only to the performance of the executable terms of the contract. Smart contracts do not replace natural language contracts but instead function as a computer program that connects to a natural language contract through an addendum that attempts to establish an inviolable link between the program and a natural language contract. The result tends to be that rather than simplifying the problem, two sets of professionals are now needed: lawyers to draft and understand the natural language contract; and computer software engineers to draft and verify the software portion of the contract.

What is needed instead is an expressive, computationally efficient, easily auditable contractual language. Such a language should be as close to a natural language as possible while expressing necessary legal contract requirements in the clearest possible manner. It should also be capable of automatic conversion into computer-processable form for automated verification, analysis, and querying. Such a language may, for instance, facilitate someone who is neither a lawyer nor a software engineer to author a legal contract that is both legally and computationally sound and efficient.

The Relevant Prior Art Includes:

U.S. Pat. No. 9,218,339 issued to Zechner, et al. on Dec. 22, 2015, entitled “Computer-implemented systems and methods for content scoring of spoken responses” that describes systems and methods for scoring a non-scripted speech sample. A system includes one or more data processors and one or more computer-readable mediums. The computer-readable mediums are encoded with a non-scripted speech sample data structure, where the non-scripted speech sample data structure includes: a speech sample identifier that identifies a non-scripted speech sample, a content feature extracted from the non-scripted speech sample, and a content-based speech score for the non-scripted speech sample. The computer-readable mediums further include instructions for commanding the one or more data processors to extract the content feature from a set of words automatically recognized in the non-scripted speech sample and to score the non-scripted speech sample by providing the extracted content feature to a scoring model to generate the content-based speech score.

U.S. Pat. No. 9,471,667 issued to Yamamoto, et al. on Oct. 18, 2016, entitled “Systems and methods for evaluating multilingual text sequences” that describes systems and methods for scoring a response to a character-by-character highlighting task. A similarity value for the response is calculated by comparing the response to one or more correct responses to the task to determine the similarity or dissimilarity of the response to the one or more correct responses to the task. A threshold similarity value is calculated for the task, where the threshold similarity value is indicative of an amount of similarity or dissimilarity to the one or more correct responses required for the response to be scored at a certain level. The similarity value for the response is compared to the threshold similarity value. A score is assigned at, above, or below the certain level based on the comparison.

McAllester, D. and Givan, R. (1992) entitled “Natural language syntax and first-order inference” published in, Artificial Intelligence 56: 1-20., that defines a syntax for first order logic based on the structure of natural language, and which is hereby incorporated by reference in its entirety.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

Inventive systems and methods of creating and using a transparent, computer-processable contractual natural language are disclosed. The language may be considered transparent in that each sentence written in it may have one, and only one, interpretation. The language may be considered computer-processable in that it may be automatically interpreted and operated on by a suitably programmed computer. In a further embodiment the language may be made computable by the further addition of a reasoning module that may allow the automatic evaluation of inferences.

In one preferred embodiment, a set of legal contracts may be annotated. The result of the annotation may be a structured contractual database that may contain evidentiary texts made up of legal-phemes. The legal-phemes may, for instance, be text-fragments having legal relevance associated with a required set of categories and subcategories. The evidentiary texts may then be assembled to obtain a set of categorized contractual phrases in a natural language.

A knowledge representation language may be defined using a set of syntax rules, and a set of semantic rules, as described in more detail below. The syntax and semantics of the knowledge representation language may be such that together they limit written sentences or phrases to a single, unambiguous interpretation, thereby making the language transparent.

The transparent, computer-processable contractual natural language may then be a subset of the categorized contractual phrases that map to the knowledge representation language. This subset may, for instance, be determined using software modules such as, but not limited to, natural language processors that may include modules such as, but not limited to, a semantic parser and an inclusion-checker.

Once the transparent, computer-processable contractual natural language has been partially or fully obtained, a user may then write a computer-processable legal contract that may be comprised of phrases or sentences contained in the transparent, computer-proces sable contractual natural language.

As discussed in more detail below, annotating the legal documents may require providing categories to be sought. For instance, a lease agreement may contain categories such as, but not limited to, “rent”, “renewal”, “deposit”, and “parking”. Each of these categories may in turn have subcategories. For instance, the category “parking” may have subcategories such as, but not limited to, “number (of spaces)” and “cost”.

In a further embodiment of the present invention, the digital data processing system may also include a reasoning engine that may have a set of inference rules. The reasoning engine may be programmed such that it may take as an input one or more phrases or sentences written in the computer-processable contractual natural language and output, or return, one or more inferences. The reasoning engine may also or instead be provided with a particular set of phrases and a possible inference and automatically determine whether or not the possible inference follows from that particular set of phrases.

Therefore, the present invention succeeds in conferring the following, and others not mentioned, desirable and useful benefits and objectives.

It is an object of the present invention to provide a language that aids in making real-life legal contracts more transparent, i.e., in the sense that each contract phrase or sentence may have one and only one meaning.

It is a further object of the present invention to provide an expressive, computationally efficient, easily auditable contractual language.

It is another object of the present invention to reduce the need for trained professionals in producing and interpreting legal contracts.

Yet another object of the present invention is to provide a system and method of analyzing legal contracts to highlight potential risks, and facilitate decision making.

### BRIEF DESCRIPTION OF THE SEVERAL VIEWS OF THE DRAWINGS

FIG. 1 shows a schematic representation of system for creating and using a transparent, computer-processable contractual natural language.

FIG. 2 is a flow diagram showing representative steps in obtaining a transparent, computer-processable contractual natural language.

FIG. 3 is a flow diagram showing representative steps of annotating legal contracts to obtain a structured contractual database.

FIG. 4 is a flow diagram showing representative steps of obtaining a transparent, computer-processable contractual natural language by mapping categorized contractual phrases to a transparent knowledge representation language.

FIG. 5 shows a schematic representation of a representative embodiment of a system for creating and using a transparent, computable contractual natural language.

FIG. 6 shows a table of a representative syntax of a transparent knowledge representation language of the present invention.

FIG. 7 shows a table of an outline of a representative formal semantics of a transparent knowledge representation language of the present invention.

FIG. 8 shows a table of representative semantic evaluation functions of a transparent knowledge representation language of the present invention.

FIG. 9 shows a table summarizing a representative mapping of phrases obtained from a categorized contractual database to a transparent knowledge representation language of the present invention.

FIG. 10 shows a table summarizing representative inference rules for a transparent knowledge representation language of the present invention.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

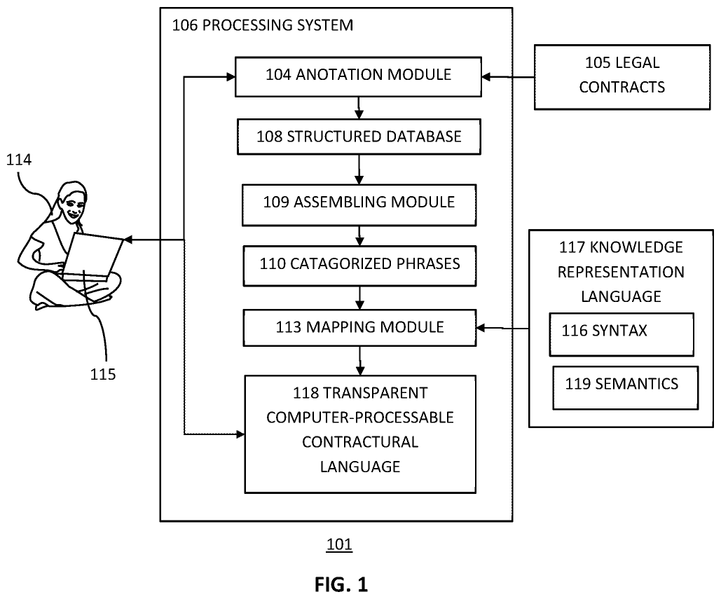

FIG. 1 shows a schematic representation 101 of system for creating and using a transparent, computer-processable contractual natural language.

The transparent, computer-processable contractual natural language 118 may be considered transparent in that each sentence in it may have one and only one interpretation. The language may be computer-processable in that it may be automatically translated into a language that may be interpreted by and operated on using a suitably programmed computer.

As shown, a set of legal contracts 105 may be procured for annotating. These legal contracts 105 may, for instance, be obtained from the practiced contract data space that may be a combination of available contracts and relevant documents as well as general legal world knowledge. These legal documents that are typically unstructured text data may be annotated by hand or may be submitted to an annotation module 104 for automated annotation, or the annotation may be a combination thereof.

The annotation software module 104 may be operable on a digital data processing system 106 that may be any suitably powerful digital computer, such as, but not limited to, an NVIDIA TITAN RTX workstation as supplied by the NVIDIA Corporation headquartered in Santa Clara, Calif.

The result of the annotation may be a structured contractual database 108 that may include evidentiary text that may include categorized legal-phemes.

An assembling software module 109, that may be operable on the same digital data processing system 106, may then be used to assemble the evidentiary texts in the database to obtain a set of categorized contractual phrases 110.

A transparent knowledge representation language 117 may be defined having a syntax 116 and semantics 119. The syntax and semantics of the transparent knowledge representation language are described in detail below and may have properties such that combined, they limit sentences or phrases written in the language to a single, unambiguous interpretation, thereby making it technically transparent. The language may resemble a natural language to the extent that it may be easily understood by someone who can read the relevant natural language.

A mapping module 113 may ascertain a subset of the categorized contractual phrases 110 that map to the transparent knowledge representation language 117. This successfully mapped subset of categorized contractual phrases may constitute the transparent, computer-processable contractual natural language 118.

A user 114 may interact with the digital data processing system 106 to produce a document such as, but not limited to, a computable legal contract 115, or legal contract template, using the transparent, computer-processable contractual natural language 118.

A simple example of a document in the transparent knowledge representation language of the present invention may read as follows:
(John-S.-Smith tenant).
(Roswitha-Stein landlord).
(New-York-State-Law (governs (this agreement))).
(New-York-State-courts jurisdiction).
not((tenant (shall-modify(equipment)) (without permission))).
IF (tenant (modify(equipment)) (without permission)) THEN (tenant pay(some penalty)).
(every indemnified party may-retain(separate lawyer)).
(any rent-transfer prohibited) and (agreement (terminates (9 Feb. 2023))).
(each party agrees (the following)).

The transparent, computer-processable, contractual natural language version of this exemplary document may read as follows:

John S. Smith is the tenant. Roswitha Stein is the landlord. New York law is the governing law. This agreement is governed by New York State law. New York State courts are the jurisdiction. A tenant shall not modify equipment without permission. If a tenant modifies equipment without permission, then a tenant pays some penalty. Every indemnified party may retain a separate lawyer. Any rent transfer is prohibited, and the agreement terminates on 9 Feb. 2023. Each party agrees to the following.

The language may be considered transparent in that each sentence or phrase may have one and only one meaning or interpretation.

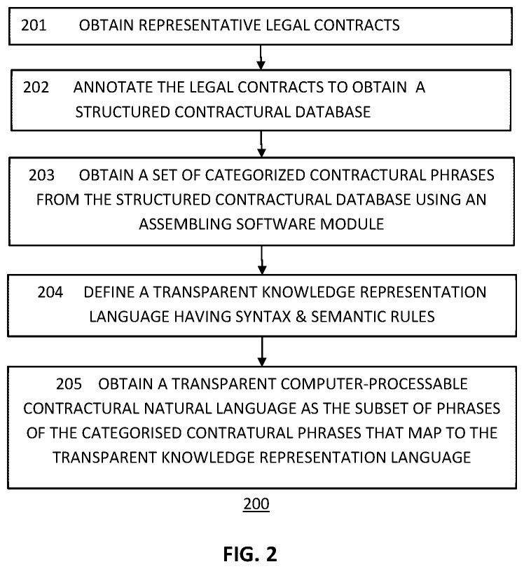

FIG. 2 is a flow diagram 200 showing representative steps in obtaining a transparent, computable contractual natural language.

In Step 201 “OBTAIN REPRESENTATIVE LEGAL CONTRACTS” a set of representative legal contracts may be obtained from the practiced contract data space. This practiced contract data space may be a combination of available contracts and relevant documents as well as general legal world knowledge. The contracts may, for instance, cover various legal contract domains such as, but not limited to, leasing agreements, professional services agreements, licensing agreements, real estate agreements, and employment agreements, or some combination thereof.

In Step 202 “ANNOTATE THE LEGAL CONTRACTS TO OBTAIN A STRUCTURED CONTRACTURAL DATABASE” the legal contracts or documents may be annotated to obtain a structured contractual database. This database may, for instance, contain evidentiary text obtained from the contracts that may contain, or be associated with, legal-phemes. The legal-phemes may be text fragments relevant to certain legal categories or subcategories.

In Step 203 “OBTAIN A SET OF CATEGORIZED CONTRACTURAL PHRASES FROM THE STRUCTURED CONTRACTURAL DATABASE USING AN ASSEMBLING SOFTWARE MODULE” a set of categorized contractual phrases may be obtained from the structured contractual database. This set of categorized contractual phrases may, for instance, be assembled from the evidentiary text containing categorized legal-phemes. The categorized contractual phrases may, for instance, be associated with the same legal categories or subcategories as the legal-phemes.

In Step 204 “DEFINE A TRANSPARENT KNOWLEDGE REPRESENTATION LANGUAGE HAVING SYNTAX & SEMANTIC RULES”, the syntax rules, i.e., the arrangement of words, symbols and phrases that create well-formed sentences, and the semantic rules, i.e., the meaning of the words, symbols, and phrases, may be defined. The meaning of a phrase or sentence may, for instance, be a condition of its truth value.

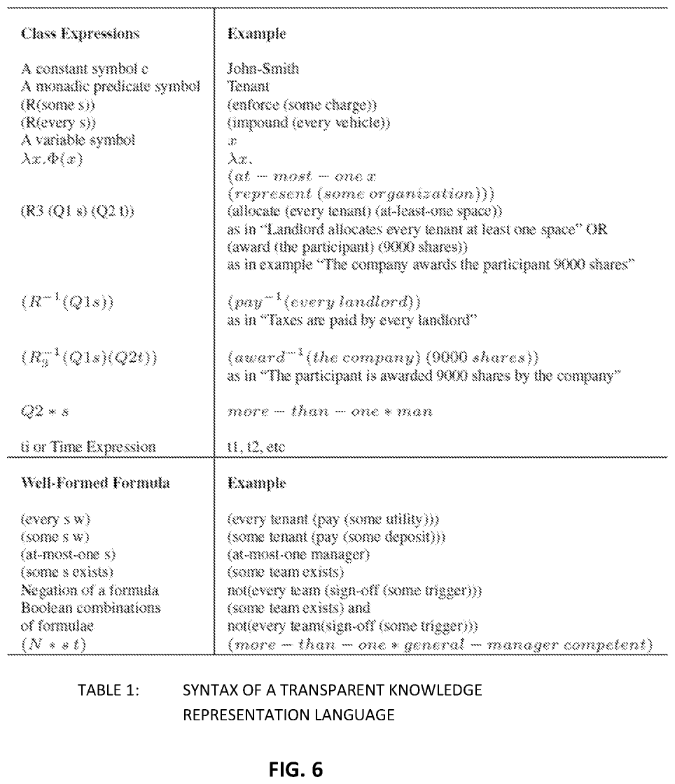

For the language to be transparent, the set of syntax rules acting in combination with the set of semantic rules must limit written sentences or phrases to a single, unambiguous interpretation. An exemplary suitable set of syntax rules in the form of class expressions and variables that may be combined into well-formed formula is shown in, for instance, Table 1 of FIG. 6.

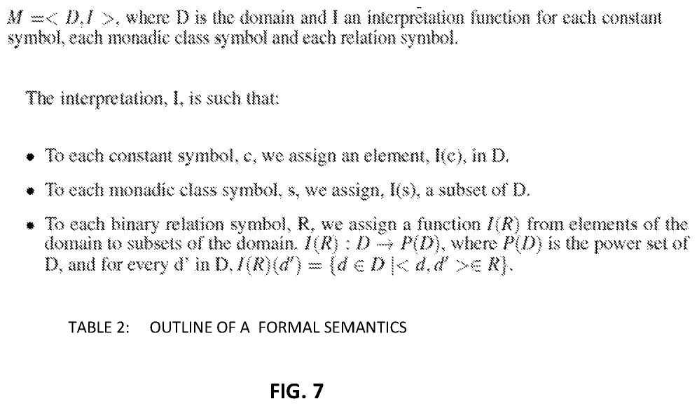

The semantic meaning of a phrase of sentence may, for instance, be a condition of its truth value. An exemplary, formal semantics suitable for use as the knowledge representation language of the present invention may use a model comprised of a domain D of elements and an interpretation function I, such that the interpretation function assigns a unique subset of the domain to each of the class expressions, variables, and formula in the syntax of the language. Such an interpretation function is shown mathematically in Table 2 of FIG. 7.

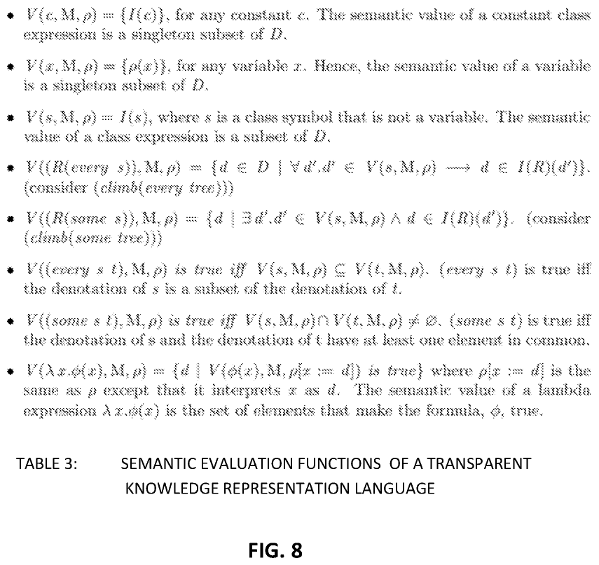

Table 3 in FIG. 8 shows representative semantic evaluation functions of a possible transparent knowledge representation language of the present invention.

In Step 205 “OBTAIN A TRANSPARENT COMPUTABLE CONTRACTURAL NATURAL LANGUAGE AS PHRASES IN THE SET OF CATEGORISED CONTRATURAL PHRASES THAT MAP TO THE TRANSPARENT KNOWLEDGE REPRESENTATION LANGUAGE” the transparent, computer-processable contractual natural language may then be the subset of contractual phrases that map to the transparent knowledge representation language, i.e., the set of phrases that may be represented using the syntax and semantic rules that may define the transparent knowledge representation language. This set may, for instance, be determined automatically using software modules such as, but not limited to, a semantic parser and an inclusion-checker that may, for instance, be a part of a natural language processor.

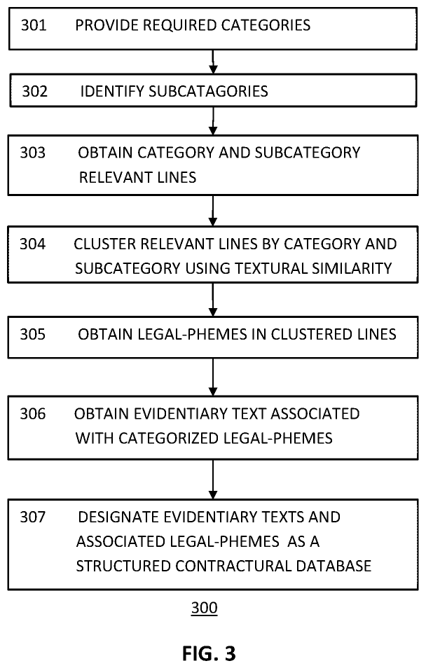

FIG. 3 is a flow diagram 300 showing representative steps of annotating legal contracts to obtain a structured contractual database.

In Step 301 “PROVIDE REQUIRED CATEGORIES” the annotation software module may need to be provided with a selected set of legal categories for annotation. These categories may depend on the legal domains being considered. For instance, a lease agreement may contain categories such as, but not limited to, “rent”, “renewal”, “deposit”, and “parking”. These categories may need to be provided by a user, or may be obtained from a preprepared table of categories applicable to the domain or domains being annotated, or some combination thereof.

In Step 302 “IDENTIFY SUBCATAGORIES” each of the categories being annotated may in turn have subcategories. For instance, the category “parking” in a leasing contract may have subcategories such as, but not limited to, “number (of spaces)” and “cost”. These subcategories may need to be provided by the user, or may be obtained from a preprepared table of subcategories applicable to the categories being annotated for, or some combination thereof.

Not all categories may have categories, resulting in zero subcategories for some categories.

In Step 303 “OBTAIN CATEGORY AND SUBCATEGORY RELEVANT LINES” the annotation software module may automatically analyze the legal documents to obtain a set of relevant lines associated with one or more of the selected categories or subcategories. This analysis may also or instead be done in part or in whole by a human operator, such as, but not limited to, skilled legal professionals, by unskilled workers following a rubric, or by machine learning algorithms, or some combination thereof.

In Step 304 “CLUSTER RELEVANT LINES BY CATEGORY AND SUBCATEGORY USING TEXTURAL SIMILARITY” the relevant lines obtained in the previous step may be clustered by the categories and/or subcategories they were deemed to be relevant to. This clustering may, for instance, be accomplished using a technique such as, but not limited to, textural similarity or alignment.

In Step 305 “OBTAIN LEGAL-PHEMES IN CLUSTERED LINES” the clustered relevant lines may be analyzed for legal-phemes, i.e., for text-fragments that may be relevant to the categories or subcategories. In analogy to graphemes being the smallest meaningful contrastive unit in a writing system, a legal-pheme may be defined as a compact text fragment having a legally relevant association to one of the categories or subcategories being analyzed. The result of this analysis may be a set of categorized legal-phemes.

In Step 306 “OBTAIN EVIDENTIARY TEXT ASSOCIATED WITH CATEGORIZED LEGAL-PHEMES” evidentiary text may be obtained for the set of categorized legal-phemes.

In Step 307 “DESIGNATE EVIDENTIALRY TEXTS AS STRUCTURED CONTRACTURAL DATABASE” the list of evidentiary texts associated with the categorized legal-phemes that may have been obtained in the previous step, along with the associated legal phemes, may be designated as being the structured contractual database that may be the required result of the annotation.

The evidentiary texts and their associated legal-phemes may later be used to assemble a list of categorized phrases.

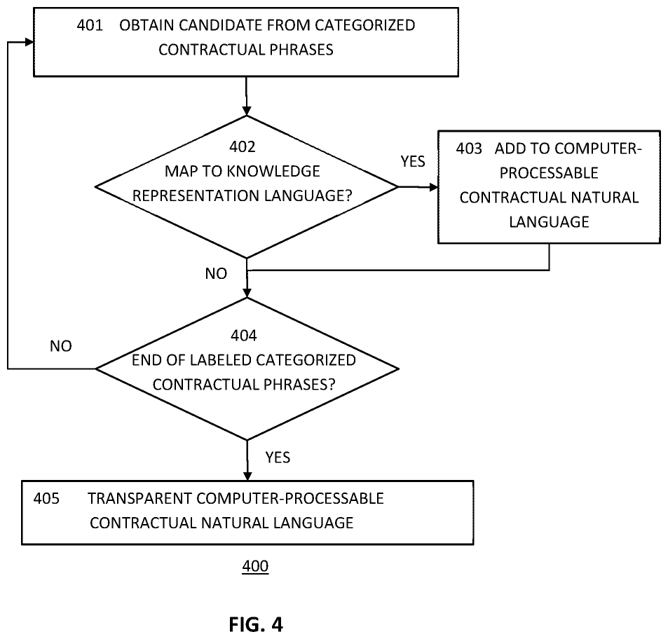

FIG. 4 is a flow diagram 400 showing representative steps of obtaining a transparent, computer-processable contractual natural language by mapping the categorized contractual phrases to a transparent knowledge representation language.

In Step 401 “OBTAIN CANDIDATE FROM LABELED CATEGORIZED CONTRACTUAL PHRASES” a contractual phrase representative of a legal category or subcategory may be obtained from a set of categorized contractual phrases.

In Step 402 “MAP TO KNOWLEDGE REPRESENTATION LANGUAGE′?” an attempt may be made to map the contractual phrase selected in the previous step into a transparent knowledge representation language such as, but not limited to, to the transparent knowledge representation language of the present invention described above. This attempt at mapping may, for instance, be accomplished using a suitably programmed semantic parser and a suitably programmed inclusion-checker. The inclusion checker and semantic parser may, for instance, be part of a natural language processor.

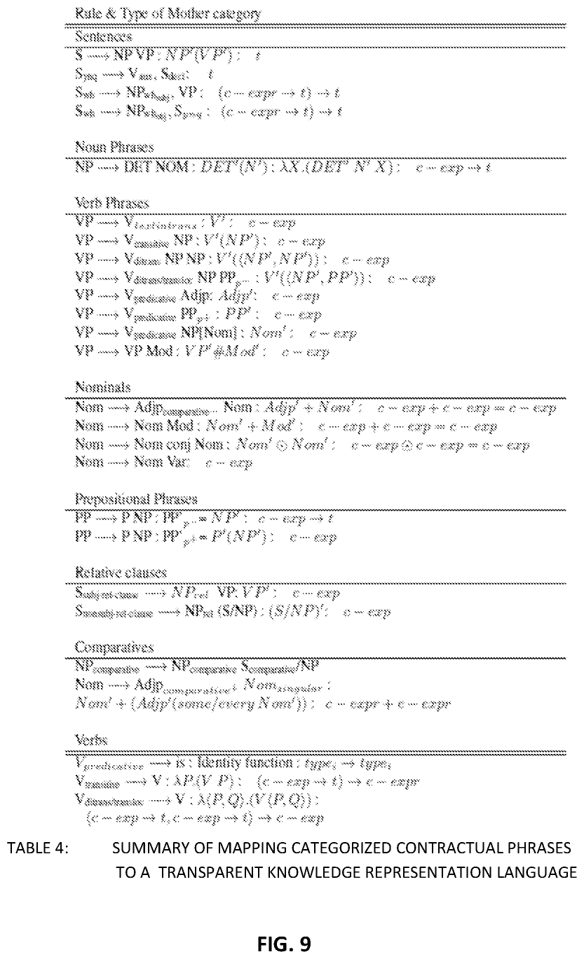

Table 4 in FIG. 9 shows a summary of representative rules that may, for instance, be used for mapping categorized contractual phrases to a transparent knowledge representation language.

If the mapping is successful, i.e., if the selected phrase may be represented using the syntax and semantic rules of the transparent knowledge representation language, then the process may proceed to step 403.

In Step 403 “ADD TO COMPUTABLE CONTRACTUAL NATURAL LANGUAGE” the successfully mapped contractual phrase may now be added to, and become a part of, the transparent, computer-processable contractual natural language. The process would then proceed to Step 404.

If, however, in Step 402, the selected phrase cannot be successfully mapped to the transparent knowledge representation language, then the phrase may not be added to it, and the process may proceed directly to Step 404.

In Step 404 “END OF LABELED CATEGORIZED CONTRACTUAL PHRASES′?” a check may be made to see if the list of categorized contractual phrases has been exhausted. If it has not been, the process may loop back to Step 401 and repeat at least steps 401 and 402.

If the list of categorized contractual phrases has been exhausted, the process may proceed to Step 405.

In Step 405 “TRANSPARENT COMPUTER-PROCESSABLE CONTRACTUAL NATURAL LANGUAGE” all the categorized contractual phrases that mapped to the transparent knowledge representation language may now be considered to be the transparent, computable contractual natural language.

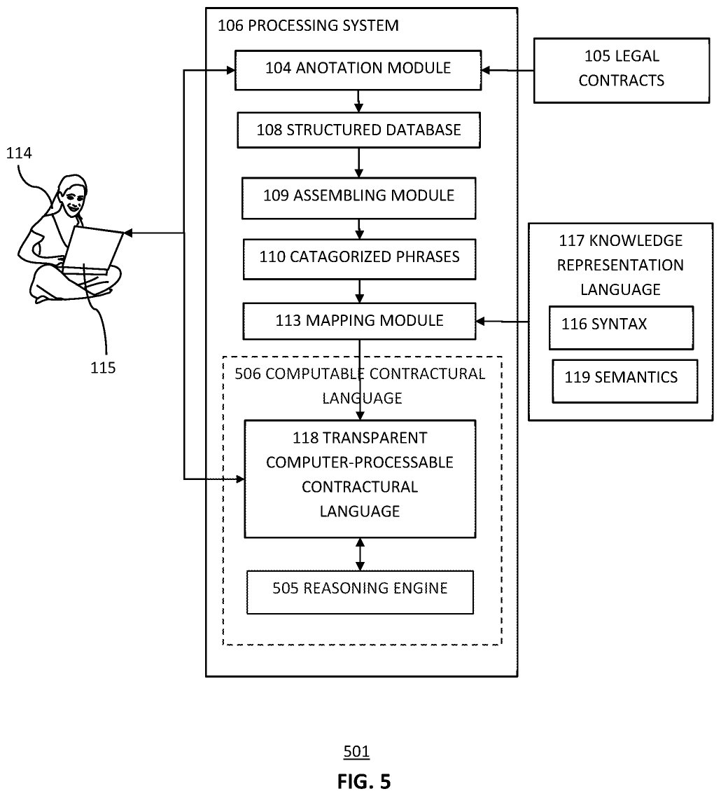

FIG. 5 shows a schematic representation 501 of a representative embodiment of a system for creating and using a transparent, computable contractual natural language.

As with the embodiment of FIG. 1, this embodiment may include a digital data processing system 106 on which a number of software modules may be operative such as, but not limited to, an annotation module 104, an assembling software module 109, and a mapping module 113. As with the embodiment of FIG. 1, this embodiment may support databases such as, but not limited to, a structured contractual database 108 and a database of categorized contractual phrases 110, and may receive data in the form of a set of legal contracts 105.

The embodiment of FIG. 5 may also include a reasoning engine 505, that may be operable on the digital data processing system 106. The reasoning engine that may have a set of inference rules and may be programmed such that it may take as an input one or more phrases or sentences written in the transparent, computable contractual natural language and may output, or return, one or more inferences.

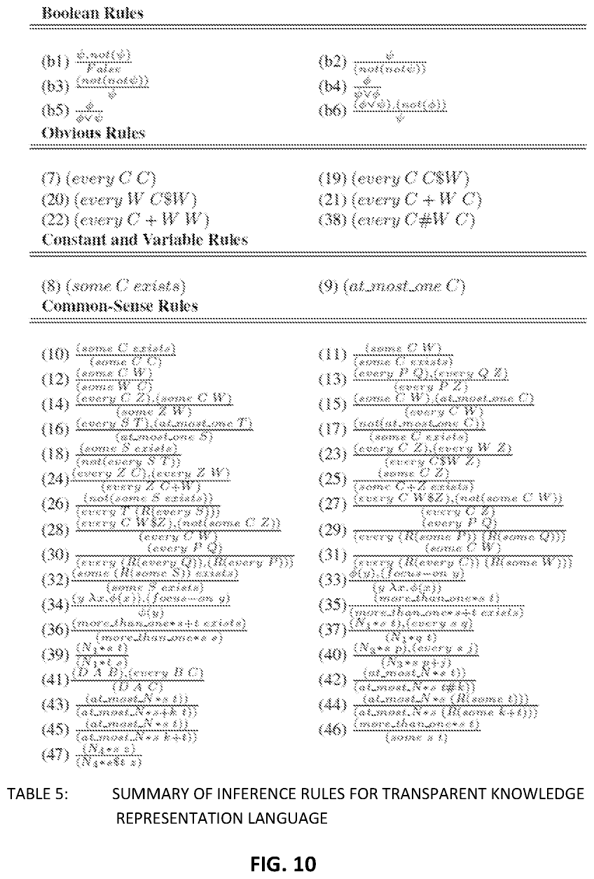

Table 5 in FIG. 10 shows a summary of representative inference rules that may, for instance, be used in evaluating transparent knowledge representation language expressions.

The reasoning engine may also or instead be programmed such that, when provided with a particular set of phrases and a possible inference, it may automatically determine whether or not the possible inference follows from that particular set of phrases.

As shown in both FIGS. 1 and 8, a user 114 may be connected to the digital data processing system 106 via a suitably programmed digital computer having a user interface that may have one or more structured menus. By interacting with the structured menus, the user may, for instance, interact with the transparent, computer-processable contractual natural language 118 to select desired phrases. This interaction may then be mediated by the reasoning engine 505 to, for instance, determine if particular inferences follow from the selected phrases. With the added oversight of the reasoning engine 505, the user may now effectively be interacting with a computable contractual language 506, i.e., the transparent, computer-processable contractual natural language 118 may have been made “computable” in the sense that the system can verify the logic of the documents as well as their syntax and semantics.

Furthermore, the user may use the interface to present the digital data processing system 106 with a legal contract, and a query which is a sentence or phrase belonging to the transparent, computer-processable contractual natural language.

Appropriate software modules operable on the digital data processing system may also automatically markup the legal contract by highlighting one or more of the locations in the legal contract corresponding to the category or subcategory associated with the query. The software may also automatically flag the highlighted locations with text or symbols representative of the corresponding category or subcategory that may have been highlighted before returning, or making available, the marked up legal contract to the user.

FIG. 6 shows a table of a representative syntax of a transparent knowledge representation language of the present invention.

As shown in Table 1 of FIG. 6, R may be a symbol representing a binary relation. s, t and w may be class expressions, x may be a variable, and Φ may represent a well-formed formula. R⁻¹ may represent the inverse of R. λ may represent a lambda function.

R₃ may be a 3-ary relationship, and R₃⁻¹ may be an inverse of a 3-ary relationship. In general, Rₙ may be a 3-ary relationship, and Rₙ⁻¹ may be an inverse of a n-ary relationship, where n is a positive number greater than 1.

Qi are quantifier symbols including “some” and “every”, i.e., any quantifier and determiner. Ti is a time expression.

FIG. 7 shows a table 701 of an outline of a representative formal semantics of a transparent knowledge representation language of the present invention.

As shown in Table 2, a formal semantics of a transparent knowledge representation language may require a model M consisting of a domain of elements D and an interpretation function I. The interpretation function may assign a unique subset of the domain to each of the class expressions, variable and formulas in the syntax of the language.

FIG. 8 shows a table of representative semantic evaluation functions of a transparent knowledge representation language of the present invention.

FIG. 9 shows a table summarizing a representative mapping of categorized contractual phrases to a transparent knowledge representation language of the present invention.

FIG. 10 shows a table summarizing representative inference rules for a transparent knowledge representation language of the present invention.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of creating and using a transparent, computer-proces sable contractual natural language, comprising:
providing a set of legal contracts in machine readable form;
annotating said legal contracts to obtain a structured contractual database comprising evidentiary text comprised of categorized legal-phemes;
assembling said evidentiary text to obtain a set of categorized contractual sentences or phrases in natural language;
defining a knowledge representation language having a set of syntax rules and a set of semantic rules that, combined, limit written sentences or phrases to a single, unambiguous interpretation;
automatically determining a sub-set of said categorized contractual sentences or phrases that map to said knowledge representation language, said sub-set being a transparent, computer-processable contractual natural language; and,
writing, by a user, a computer processable legal contract comprised of sentences or phrases contained in said transparent, computer-processable contractual natural language.

2. The method of claim 1, wherein, annotating said legal contracts further comprises:
providing a set of required categories and subcategories;
obtaining, in said legal contracts, a set of relevant lines associated with one or more of said categories or subcategories;
clustering said relevant lines by one or more of said categories or subcategories using textual similarity or alignment;
obtaining, in each of said clustered, relevant lines, one or more legal-phemes representative of one or more of said categories or subcategories thereby obtaining a set of categorized legal-phemes; and,
associating one or more of said categorized, legal-phemes with an evidentiary text obtained from said relevant lines.

3. The method of claim 2, wherein said categorized legal-phemes are text-fragments relevant to said categories and subcategories

4. The method of claim 1, wherein, said syntax rules require each sentence to conform to the structure of a well-formed formula comprising one or more n-ary relations of class expressions and variables, where n is a positive integer greater than one.

5. The method of claim 4, wherein, said class expressions comprise a constant symbol, a monadic predicate symbol, a variable symbol, an n-ary relation symbol and an inverse of a n-ary relation symbol.

6. The method of claim 4, wherein, said set of semantic rules comprises a domain of elements, and an interpretation function that assigns a unique subset of said domain to each of said class expressions, variables, and formulas.

7. The method of claim 1, further comprising defining a reasoning mechanism associated with said knowledge representation language; and,
automatically determining a validity of a set of terms and conditions written in said transparent computer-processable contractual natural language using the said reasoning mechanism, thereby making said transparent computer-proces sable contractual natural language computable.
